(19) United States
(12) Patent Application Publication
(10) Pub. No.: US 2015/0045969 A1
(43) Pub. Date: Feb. 12, 2015

(54) ORKA SUBSEA PIGGING AND HYDROTESTING UNIT

(71) Applicant: Halliburton Energy Services, Inc., Houston, TX (US)

(72) Inventors: Laurence James Abney, Sandnes (NO); James Robert MacLennan, Aberdeen (GB); Brian McGillivray, Tananger (NO); Ramsey Martin, Gosport (GB)

(73) Assignee: Halliburton Energy Services, Inc., Houston, TX (US)

(21) Appl. No.: 13/963,420

(22) Filed: Aug. 9, 2013

(51) Int. Cl. G05D 7/06

(52) U.S. Cl. CPC G05D 7/0629
USPC 700/282

(57) ABSTRACT

A subsea pipeline apparatus is disclosed, including a multifunction unit, an inlet to direct fluid toward the multifunction unit, and energy storage unit connected to the multifunction unit, and an outlet configured to receive fluid passed through the multifunction unit. The multifuntion unit may operate in at least two modes: a generator mode, allowing the generation of energy from the flow of fluid, and a motor mode, allowing the fluid to be forced to the outlet and into the subsea pipeline.

### BACKGROUND

The present invention relates generally to operations performed and equipment utilized in conjunction with a subsea pipeline and, in particular, to subsea pigging and hydrostatic testing operations.

After fabrication, a pipeline must be pre-commissioned through a process that typically involves cleaning, filling the pipeline with water, and hydrostatically testing the pipeline to prove its integrity and confirm the pipeline has no leaks. In the case of a subsea pipeline, the pressure difference between the interior of the pipe and the surrounding sea can be used to fill the pipeline or assist in the pigging process by allowing water from the sea to enter the pipeline.

However, for many reasons, simply opening a valve to direct water into the pipe is not sufficient to fill the pipeline or drive a pig through the pipeline, including because the flow rate must be controlled and simply utilizing the pressure difference will not obtain a complete filling of the pipeline. Initially in a flooding operation, the driving differential pressure is at a maximum, where the pipeline could flood too quickly if the flow rate is not controlled. As the flooding operation continues and the pipeline becomes progressively filled, the driving differential pressure decreases until the pressures substantially equalize and the differential pressure is no longer sufficient to fill the pipeline. At this point, intervention is required to complete the flooding operation.

The subsea pre-commissioning process typically involves a ship positioned on the spot and containing equipment to facilitate the pre-commissioning operation. Units known as subsea pigging units or hydrotesting units have been used to complete the pipeline filling operation and perform the hydrostatic testing operation on the sea floor. These subsea pigging and hydrotesting units are often powered from and controlled by a surface vessel.

### FIGURES

Some specific exemplary embodiments of the disclosure may be understood by referring, in part, to the following description and the accompanying drawings.

FIG. 1 illustrates an example diagram of system components that incorporates one or more principles of the present disclosure, according to aspects of the present disclosure.

FIG. 2 illustrates an example multifunction unit assembly, according to aspects of the present disclosure

FIG. 3 illustrates an example graph of differential driving pressure during a flooding operation, according to aspects of the present disclosure.

While embodiments of this disclosure have been depicted and described and are defined by reference to exemplary embodiments of the disclosure, such references do not imply a limitation on the disclosure, and no such limitation is to be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DETAILED DESCRIPTION

The present invention relates generally to operations performed and equipment utilized in conjunction with a subsea pipeline and, in particular, to subsea pigging and hydrostatic testing operations.

Illustrative embodiments of the present disclosure are described in detail herein. In the interest of clarity, not all features of an actual implementation may be described in this specification. It will of course be appreciated that in the development of any such actual embodiment, numerous implementation-specific decisions must be made to achieve the specific implementation goals, which will vary from one implementation to another.

Moreover, it will be appreciated that such a development effort might be complex and time-consuming, but would nevertheless be a routine undertaking for those of ordinary skill in the art having the benefit of the present disclosure.

The terms “couple” or “couples” as used herein are intended to mean either an indirect or direct connection. Thus, if a first device couples to a second device, that connection may be through a direct connection, or through an indirect mechanical or electrical connection via other devices and connections. The term “uphole” as used herein means along the drillstring or the hole from the distal end towards the surface, and “downhole” as used herein means along the drillstring or the hole from the surface towards the distal end.

To facilitate a better understanding of the present disclosure, the following examples of certain embodiments are given. In no way should the following examples be read to limit, or define, the scope of the disclosure. Embodiments of the present disclosure may be applicable to rigid steel pipelines, rigid steel connections spools, composite flexible flowlines, composite flexible connection jumpers, pig launchers, pig receivers, connection hub end caps, or other pipeline features in any type of subsea configuration. Embodiments may be applicable to any subsea pipeline system including natural resource production transport, water injection, and service chemical transport. Embodiments described below with respect to one implementation are not intended to be limiting.

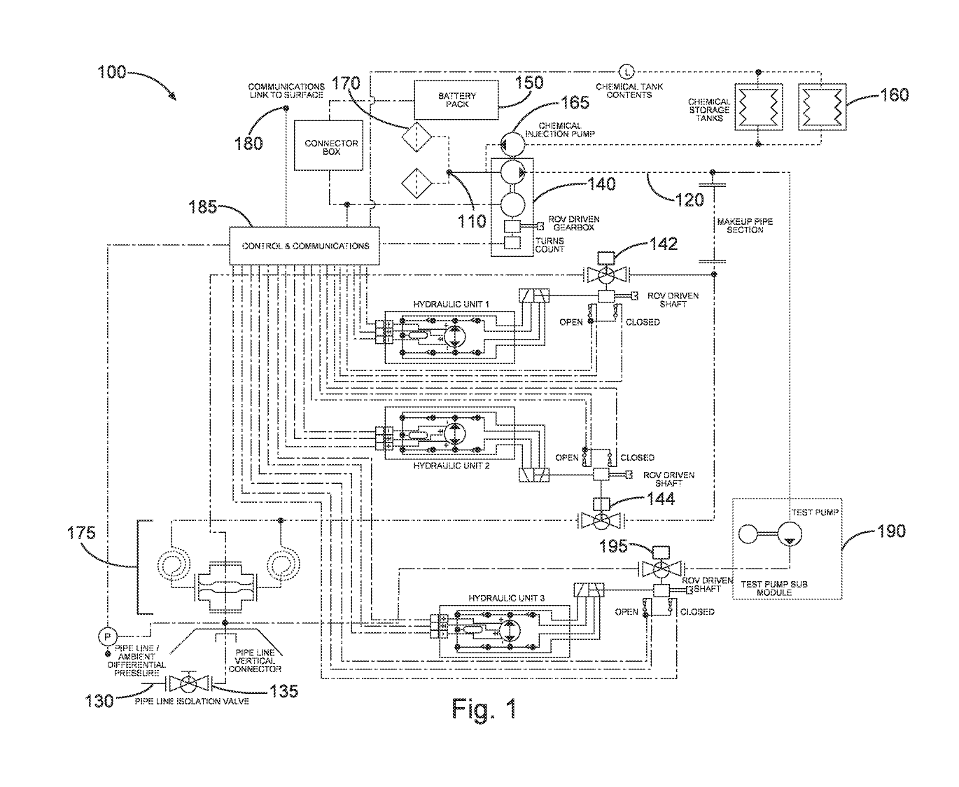

Referring to FIG. 1, an example schematic diagram of a remote subsea unit 100 is shown. In certain embodiments, the remote subsea unit 100 may include an inlet 110 connected to a pipeline 130 via subsea unit conduit 120. In certain embodiments, fluid entering the inlet 110 may be directed through at least one filter 170 able to purify sea water entering the inlet 110 to a required standard. A multifunction unit 140 may be located in the subsea unit conduit 120 such that water flowing from the inlet 110 and through the subsea unit conduit 120 may be directed through the multifunction unit 140. In certain embodiments, the remote subsea unit 100 may include a battery 150 electrically connected to the multifunction unit 140. In certain embodiments, the battery 150 may be any of a deep charge lead acid battery, lithium ion battery, nickle metal hydride battery, lithium air battery, and lithium polymer battery, or any other battery suitable for subsea operations.

In certain embodiments, the remote subsea unit 100 may include at least one chemical storage tank 160 configured to inject a desired additive chemical to the fluid in the subsea unit conduit 120. In an embodiment, a chemical injection pump 165 may be in fluid communication with the at least one chemical storage tank 160 and configured to assist flow of additive chemicals into the subsea unit conduit 120. The chemical injection pump 165 may control the flow rate of additive chemicals to be proportional to the water flow rate. In an embodiment, the remote subsea unit 100 may include a communications link 180. The communications link 180 may allow communication between the remote subsea unit 100 and an operator and allow the operator to control the remote subsea unit 100 via a control and communications device 185. The battery 150 may be electrically connected to the control and communication device 185 and configured to provide electrical power to the control and communication device 185.

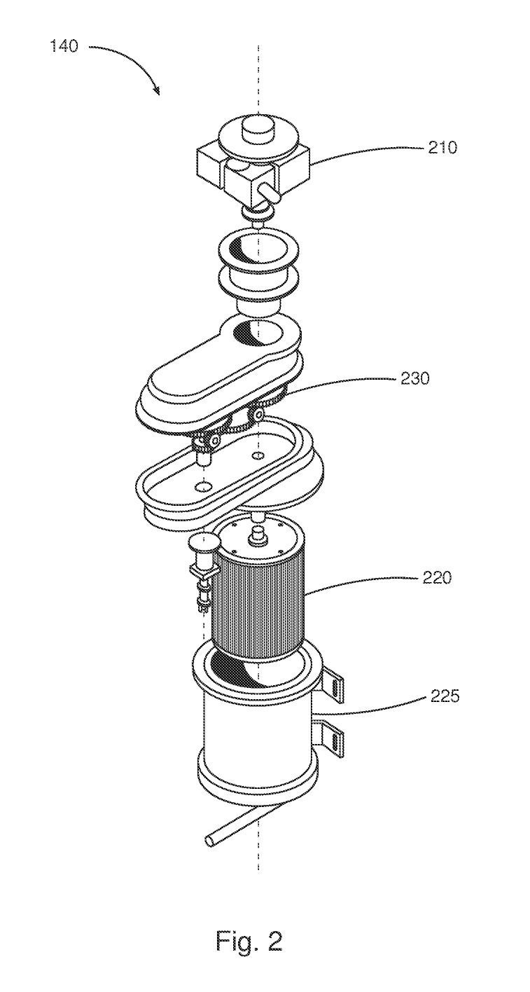

Referring now to FIG. 2, an example assembly view of an embodiment of the multifunction unit 140 is shown, according to aspects of the present disclosure. The multifunction unit 140 may include a boost pump 210 coupled to a motor generator 220 via a gearbox 230. The motor generator 220 may be located in a motor generator housing 225. In certain embodiments, the motor generator 220 may be an electric motor generator. In further embodiments, the motor generator 220 may be a DC electric motor generator.

The multifunction unit 140 may be configured to operate in at least two modes: a generator mode and a motor mode. In the generator mode, fluid flowing through the boost pump 210 may cause the boost pump to rotate. The rotation of the boost pump 210, via the gearbox 230, drives the motor generator 220, generating electricity that may be directed to a battery 250 connected to the motor generator 220 to store generated electrical energy.

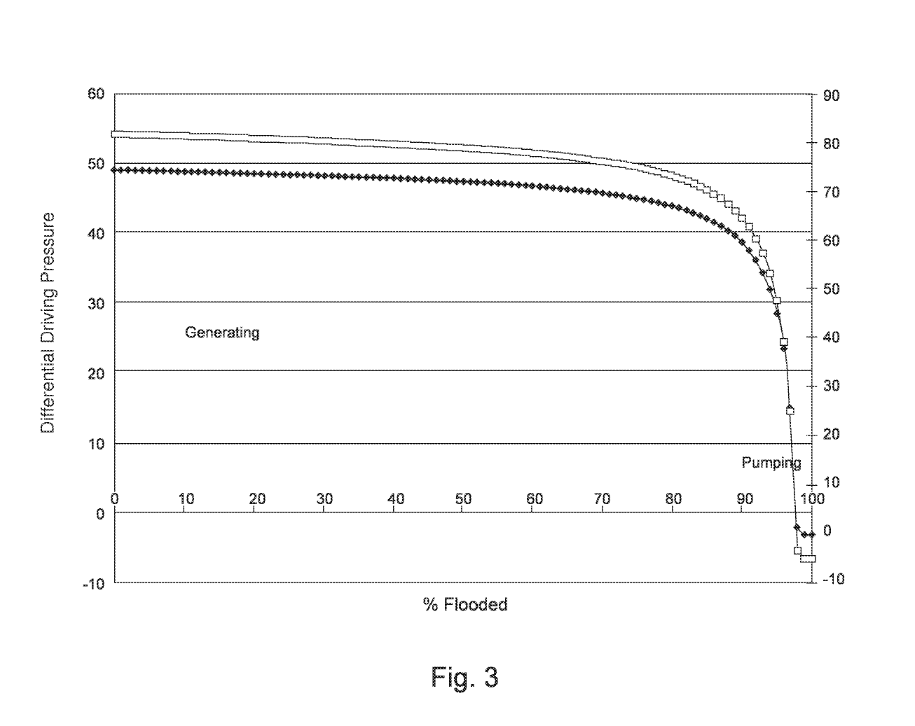

When the multifunction unit 140 is in the motor mode, the motor generator 220 may drive the boost pump 210 to drive the boost pump 210 via the gearbox 230, directing fluid through the subsea unit conduct 120. In certain embodiments, once the flooding operation reaches a predetermined completion point, the multifunction unit 140 may be switched from the generator mode to the motor mode. Once in the motor mode, the boost pump 210 may direct fluid to the pipeline 130 to complete flooding of the pipeline 130. In certain embodiments, the predetermined completion point may be set by comparing the difference between the seabed pressure and the inner pipeline pressure. Referring to FIG. 3, an example chart of the differential driving pressure between the seabed and the pipeline is shown as a function of percentage of pipeline flooded during the course of a flooding operation. In the example embodiment shown, the differential driving pressure is positive at the beginning of the flooding operation, where the seabed pressure is greater than the inner pipeline pressure, and decreases slowly the flooding operation progresses. Once the pipeline is substantially flooded, the differential driving pressure decreases sharply until it becomes negative. When the differential driving pressure and/or the flow rate decreases below a desired point, the multifunction unit 140 may switch to motor mode and drive the boost pump 210 to direct fluid to the pipeline 130 to complete the pipeline flooding operation. In certain embodiments, the multifunction unit 140 may be switched to motor mode at the point when the driving pressure becomes negative.

Referring again to FIG. 1, in certain embodiments, the remote subsea unit 100 may include a variable choke 175 configured to control or adjust the flow of fluid into the pipeline 130. In certain embodiments, the variable choke 175 may control the flow rate through a programmable logic controller (PLC) feedback sensor to actuate a choke valve in response to changes in the flow rate. In certain embodiments, the variable choke 175 may adjust the flow rate using a dynamic braking and feedback PLC circuit. In certain embodiments, the remote subsea unit 100 may include a pipeline isolation valve 135 disposed between the subsea unit conduit 120 and the pipeline 130.

The remote subsea unit 100 may include pipeline flooding valves 142, 144. The pipeline flooding valves 142, 144 may be remotely operated via the control and communications unit 185 and communications link 180 and may be electrically powered by the battery 150. In certain embodiments, an operator may remotely open the pipeline flooding valves 142, 144 to begin flooding operations. In certain embodiments, remote operation and control of the remote subsea unit 100 may be accomplished through low frequency signals, between about 3-300 Hz and acoustic telemetry. A remotely operated vehicle may also be used to operate the pipeline flooding valves 142, 144. In certain embodiments, after the pipeline flooding operation is completed, the pipeline flooding valves 142, 144 may be closed.

In certain embodiments, the remote subsea unit may include a hydrostatic testing pump 190 and hydrostatic testing valve 195. The hydrostatic testing pump 190 and hydrostatic testing valve 195 may be electrically connected to the control and communications device 185 to allow remote operation of the hydrostatic testing pump 190 and hydrostatic testing valve 195. The hydrostatic testing pump 190 and hydrostatic testing valve may be electrically powered by the battery 150. In certain embodiments, the remote subsea unit 100 may be used to hydrostatically test the flooded pipeline 130 by closing the pipeline flooding valves 142, 144, opening the pipeline testing valve 190, and opening the pipeline isolation valve 175. In certain embodiments, the hydrostatic testing process may be initiated automatically after completion of the flooding operation. In certain embodiments, the remote subsea unit 100 may be used to drive a pig through the pipeline 130.

The remote subsea unit 100 may allow initiation and completion of a remote flooding operation without requiring a surface or outside power source. The multifunction unit 140 may generate electrical power using the flow of water caused by the differential driving pressure and store the generated electrical power in a battery 150. The electrical power generated by the multifunction unit 140 may be greater than the electrical power required by the multifunction unit 140 in motor mode to finish the pipeline flooding operation. Thus, the battery 150 may be used to power other various aspects and operations of the remote subsea unit 100, such as electro chlorination, UV sterilization, logger functions, and remote telemetry.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. Also, the terms in the claims have their plain, ordinary meaning unless otherwise explicitly and clearly defined by the patentee. The indefinite articles “a” or “an,” as used in the claims, are defined herein to mean one or more than one of the element that it introduces.

What is claimed is:

1. A subsea pipeline apparatus, comprising:
a multifunction unit, comprising:
a boost pump,
an electric motor generator, and
a gearbox operably coupled to the boost pump and the electric motor generator;
an inlet configured to direct fluid toward the multifunction unit;
an energy storage unit connected to the multifunction unit;
an outlet configured to receive fluid from the multifunction unit.

2. The apparatus of claim 1, wherein the energy storage unit is configured to receive energy generated by the multifunction unit.

3. The apparatus of claim 2, wherein the energy storage unit is configured to direct energy to the multifunction unit.

4. The apparatus of claim 1, wherein the multifunction unit is configured to operate in a generator mode and a motor mode, wherein the multifunction unit in the generator mode is configured to generate energy from fluild flow and direct energy to the energy storage unit, wherein the multifunction unit in the motor mode is configured to receive energy from the energy storage unit.

5. The apparatus of claim 1, further comprising:
a communications link; and
a control unit connected to the communications link and the multifunction unit, wherein the control unit is configured to receive control signals from the communications link and the multifunction unit is controlled by the control unit.

6. The apparatus of claim 5, wherein the outlet further comprises a pipeline isolation valve, wherein the control unit is configured to actuate the pipeline isolation valve upon receipt of a pipeline isolation valve open signal.

7. The apparatus of claim 1, wherein the energy storage unit is connected to the control unit.

8. The apparatus of claim 1, wherein the inlet further comprises at least one filter.

9. The apparatus of claim 1, further comprising:
an additive chemical storage;
an additive chemical storage pump fluidically connected to the additive chemical storage and configured to direct additive chemicals toward the outlet.

10. The apparatus of claim 1, further comprising a variable choke configured to receive fluid from the multifunction unit.

11. A method of flooding a subsea pipeline, comprising:
providing a multifunction unit, comprising:
a boost pump,
an electric motor generator, and
a gearbox operably coupled to the boost pump and the electric motor generator;
opening a pipeline isolation valve;
directing fluid through an inlet toward the multifunction unit;
receiving fluid the multifunction unit;
generating energy from the flow of fluid through the multifunction unit.

12. The method of claim 11, further comprising storing energy generated by the multifunction unit in an energy storage unit.

13. The method of claim 12, further comprising:
switching the multifunction unit to a motor mode,
supplying the multifunction unit with energy from the energy storage unit, and
using the multifunction unit to direct fluid toward the outlet.

14. The method of claim 13, wherein switching the multifunction unit to the motor mode occurs at a predetermined point of flooding the subsea pipeline.

15. The method of claim 13, wherein opening a pipeline isolation valve further comprises:
sending a control signal to a communications link,
directing the control signal to a control unit, and
actuating the pipeline isolation valve by the control unit.

16. A subsea pipeline apparatus, comprising:
a multifunction unit, comprising:
a boost pump,
an electric motor generator, and
a gearbox operably coupled to the boost pump and the electric motor generator;
an inlet configured to direct fluid toward the multifunction unit;
an energy storage unit connected to the multifunction unit, wherein the energy storage unit is configured to receive energy generated by the multifunction unit and direct energy to the multifunction unit;
an outlet configured to receive fluid from the multifunction unit.

17. The apparatus of claim 15, further comprising:
a communications link; and
a control unit connected to the communications link and the multifunction unit, wherein the control unit is configured to receive control signals from the communications link and the multifunction unit is controlled by the control unit.

18. The apparatus of claim 15, wherein the inlet further comprises at least one filter.

19. The apparatus of claim 15, further comprising:
an additive chemical storage;
an additive chemical storage pump fluidically connected to the additive chemical storage and configured to direct additive chemicals toward the outlet.

20. The apparatus of claim 15, further comprising a variable choke configured to receive fluid from the multifunction unit.
